(19) United States
(12) Patent Application Publication
(10) Pub. No.: US 2026/0032204 A1
(43) Pub. Date: Jan. 29, 2026

(54) ELECTRONIC DEVICE, CONTROL METHOD FOR CONTROLLING THE SAME, AND STORAGE MEDIUM

(71) Applicant: CANON KABUSHIKI KAISHA, Tokyo (JP)

(72) Inventor: SHODAI YANO, Tokyo (JP)

(21) Appl. No.: 19/270,984

(22) Filed: Jul. 16, 2025

(30) Foreign Application Priority Data
Jul. 23, 2024 (JP) 2024-118270

(51) Int. Cl. H04N 1/00

(52) U.S. Cl. CPC H04N 1/00474; H04N 1/00413; H04N 2201/0094

(57) ABSTRACT

An electronic device performs a process of displaying a first screen including a predetermined item, control to execute a predetermined function based on an operation on the predetermined item on the first screen, control to display the first screen without displaying a guide regarding the predetermined item when an event where the first screen is to be displayed occurs and in a case where a predetermined condition corresponding to a state where the predetermined item is not operated even in a case where the first screen has been displayed is not satisfied, and control to display the guide when an event where the first screen is to be displayed occurs and in a case where the predetermined condition is satisfied.

### BACKGROUND

### Field of the Technology

The present disclosure relates to an electronic device, a control method for controlling the same, and a storage medium, and in particular, to a technique for displaying a guide regarding a function.

### Description of the Related Art

In recent years, users of an electronic device may not know the existence of a function and an operation method for a function of the electronic device due to the multifunctionalization of the electronic device, and as such cannot fully utilize the functions of the electronic device. In response, a technique for notifying a user of the existence of a function and an operation method for the function by displaying a guide is also discussed. Japanese Patent Application Laid-Open No. 2007-86823 discusses a technique that takes into account a case where the continuation of the display of an operation method is cumbersome for a user proficient in an operation. Specifically, Japanese Patent Application Laid-Open No. 2007-86823 discusses a technique for storing the number of times an operation on a guide target is performed, and if the number of times exceeds a predetermined number of times, not subsequently displaying a guide.

In Japanese Patent Application Laid-Open No. 2007-86823, the guide continues to be displayed until the operation on the guide target is performed the predetermined number of times. Thus, the guide is displayed each time until the guide ceases to be displayed. This is cumbersome for a user aware of the operation on the guide target from the start.

In Japanese Patent Application Laid-Open No. 2016-143001, to add or delete a menu item displayed on a screen, the screen transitions to a screen for customizing the screen, and a user selects addition or deletion through the screen for customizing the screen. Although all menu items can be deleted, also when a menu item is added again in the state where no menu item is displayed, the user needs to give an instruction to add the item through the screen for customizing the screen. This increases operation trouble.

### SUMMARY

The present disclosure is directed to providing a mechanism for reducing cumbersomeness due to display that guides a user through a function, while enabling the user to utilize the function more effectively.

According to an aspect of the present disclosure, an electronic device includes at least one memory storing a program and at least one processor, that when executing the stored program, causes the at least one processor to perform a process of displaying a first screen including a predetermined item, perform control to execute a predetermined function based on an operation on the predetermined item on the first screen, perform control to display the first screen without displaying a guide regarding the predetermined item when an event where the first screen is to be displayed occurs and in a case where a predetermined condition corresponding to a state where the predetermined item is not operated even in a case where the first screen has been displayed is not satisfied, and perform control to display the guide when an event where the first screen is to be displayed occurs and in a case where the predetermined condition is satisfied.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a data processing system according to an exemplary embodiment.

FIG. 2 is a block diagram illustrating a hardware configuration of an electronic device.

FIG. 3 is a block diagram illustrating a software configuration of the electronic device.

FIGS. 4A to 4D illustrate examples of display by an application.

FIGS. 5A to 5D illustrate examples of display by the application.

FIGS. 6A to 6D illustrate examples of display by the application.

FIG. 7 illustrates an example of display by the application.

FIGS. 8A to 8B illustrates a flowchart of processing of the application.

FIG. 9 illustrates a flowchart of a customization process by the application.

FIG. 10 illustrates a flowchart of a function addition process by the application.

### DESCRIPTION OF THE EMBODIMENTS

With reference to the drawings, the embodiment(s) for carrying out the present disclosure will be described below.

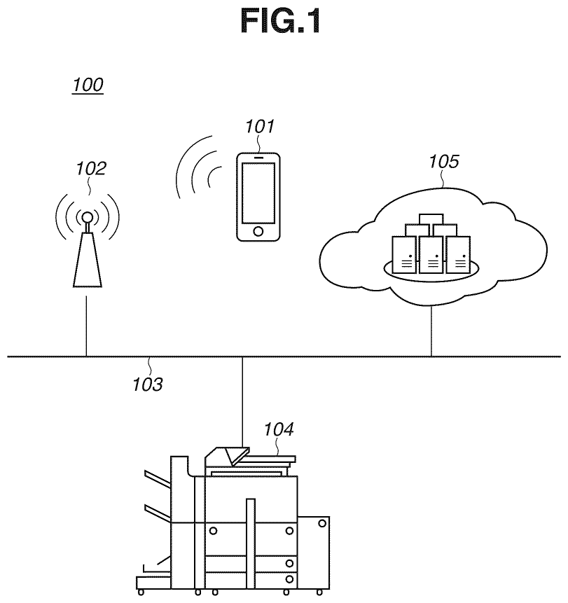

FIG. 1 is a block diagram illustrating the configuration of a data processing system according to an exemplary embodiment.

A data processing system 100 includes an electronic device 101, a wireless local area network (WLAN) terminal 102, an image forming apparatus 104, and a cloud server 105. These various devices are connected to each other via a network 103.

The electronic device 101 is a mobile terminal such as a smartphone, and includes an operating system (OS) for a small-sized terminal and programs for controlling a telephone call and data communication operations. The electronic device 101 may also be a personal computer that does not perform sound control, position detection control, and mobile phone data communication. The electronic device 101 is connected to the network 103 via the WLAN terminal 102 having the function of a WLAN access point.

The WLAN terminal 102 is a WLAN base station having a general network/router function and provides a WLAN via Wi-Fi® in a home, office, etc.

The image forming apparatus 104 (an image processing apparatus) is a digital multifunction peripheral having various job execution functions such as a printer function, a copy function, a scanner function, and a fax transmission function. A user can instruct the image forming apparatus 104 to execute a print, scan, or fax job by operating the electronic device 101.

The cloud server 105 can connect to the network 103 via the Internet. The cloud server 105 manages data used in the electronic device 101 and the image forming apparatus 104, and performs an extension process on various functions via the network 103.

The electronic device 101 and the image forming apparatus 104 can perform short-range wireless communication via a wireless signal based on near-field communication (NFC) or Bluetooth® Low Energy. The image forming apparatus 104 has information (Internet Protocol (IP)) address or a media access control (MAC) address for making a WLAN connection to the image forming apparatus 104 via an NFC communication section 210 or a Bluetooth® Low Energy communication section 211. The electronic device 101 acquires this connection information via short-range wireless communication. Then, the electronic device 101 and the image forming apparatus 104 start communicating with each other based on the acquired information.

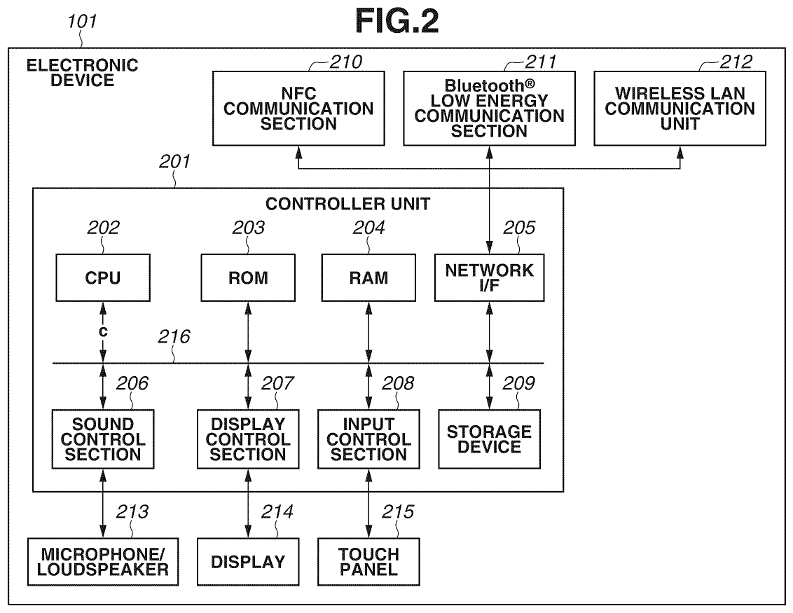

FIG. 2 is a block diagram illustrating the hardware configuration of the electronic device 101. A controller unit 201 controls various communication sections such as the NFC communication section 210, the Bluetooth® Low Energy communication section 211, a wireless LAN communication section 212, and various user interface (UI) sections such as a microphone/loudspeaker 213, a display 214, and a touch panel 215. The controller unit 201 also includes a central processing unit (CPU) 202, a read-only memory (ROM) 203, a random-access memory (RAM) 204, a network interface (I/F) 205, a sound control section 206, a display control section 207, an input control section 208, and a storage device 209. These components are connected via a system bus 216.

The CPU 202 controls the system of the electronic device 101. The ROM 203 stores the OS of the electronic device 101 and application software (hereinafter referred to as “applications”) for controlling a telephone call and data communication.

The RAM 204 is a memory for the CPU 202 to execute various programs and is a work memory area for an application to execute a program.

The storage device 209 is a non-volatile storage device (storage medium) that stores various operation mode settings that need to be stored even after a restart of the electronic device 101, and an operation log. The network I/F 205 is connected to the NFC communication section 210, the Bluetooth® Low Energy communication section 211, and the wireless LAN communication section 212 and controls various types of wireless communication between the image forming apparatus 104 and the cloud server 105.

The sound control section 206 controls the input and output of sound data via the microphone/loudspeaker 213. The display control section 207 controls the output of image data to be displayed on the display 214. The input control section 208 controls the input of information indicated through a hardware key, such as a button or the touch panel 215, by the user. Various applications executed by the electronic device 101 are provided to the user using the sound control section 206, the display control section 207, and the input control section 208.

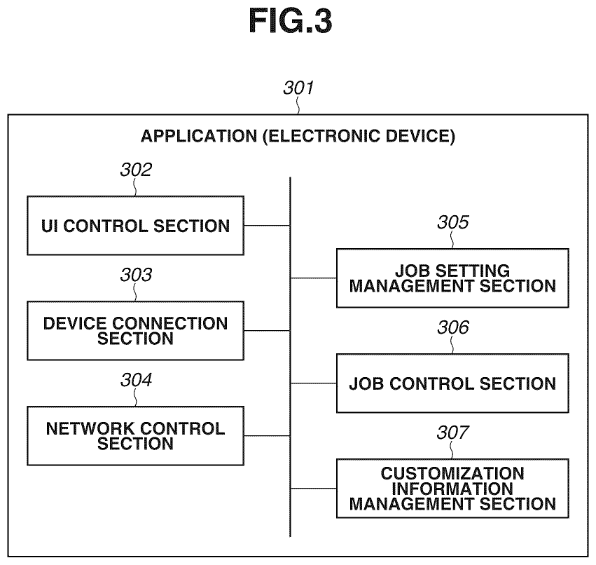

FIG. 3 is a block diagram illustrating the software configuration of the electronic device 101 according to the present exemplary embodiment.

An application 301 is software executed by the CPU 202 of the electronic device 101 and stored in the ROM 203. In the present exemplary embodiment, the application 301 is a print application that instructs the image forming apparatus 104 to execute a print, scan, or fax job.

A UI control section 302 receives job setting information input via the touch panel 215 by the user and transmits the job setting information to a job setting management section 305 via the input control section 208. The UI control section 302 also receives a response from the job setting management section 305 or a job control section 306 and outputs the response to the display 214 via the display control section 207.

A device connection section 303 establishes short-range wireless communication based on NFC or Bluetooth® Low Energy and WLAN communication via the network 103 between the electronic device 101 and the image forming apparatus 104. For example, in the case of NFC, the user brings the NFC communication section 210 of the electronic device 101 close to an NFC communication section of the image forming apparatus 104 and brings the NFC communication sections into contact with each other, thereby starting short-range wireless communication. In the case of Bluetooth® Low Energy, the user brings the Bluetooth® Low Energy communication section 211 of the electronic device 101 and a Bluetooth® Low Energy communication section of the image forming apparatus 104 close to each other, and the device connection section 303 determines that the Bluetooth® Low Energy communication sections are within a distance at which the strength of Bluetooth® Low Energy is greater than or equal to a certain strength, thereby starting short-range wireless communication.

A network control section 304 transmits job settings, a job execution instruction command, and image data to the image forming apparatus 104 via the network 103. The network control section 304 receives job setting information stored in the image forming apparatus 104 via the network 103.

The job setting management section 305 stores job setting information input by the user using the UI control section 302 and job setting information received from the image forming apparatus 104 or the cloud server 105 by the network control section 304 in the RAM 204 or the storage device 209. At this time, the job setting management section 305 manages these pieces of job setting information as “favorite” such that the pieces of job setting information are settings frequently used by the user. The job setting management section 305 also manages custom job settings stored in the RAM 204 or the storage device 209 when the application 301 is installed, as “preset”.

The job control section 306 generates job execution instruction information based on the “favorite” and “preset” job settings registered in the job setting management section 305 and transmits a job execution request to the image forming apparatus 104 via the network 103. The job control section 306 also acquires a job execution status and the operating state of a device of a scanner or a printer from the image forming apparatus 104 via the network 103 and transmits the job execution status and the operating state to the UI control section 302.

A customization information management section 307 stores information regarding the display and hiding of functions such as a print function and a scan function displayed on the display 214 by the UI control section 302 and the arrangement order of the functions in association with an identifier of the image forming apparatus 104 in the RAM 204 or the storage device 209. At this time, the customization information management section 307 manages the information regarding the display and hiding of the functions and the arrangement order of the functions as “customization information”. Regarding the customization information, the UI control section 302 acquires the content of editing input by the user via the display 214.

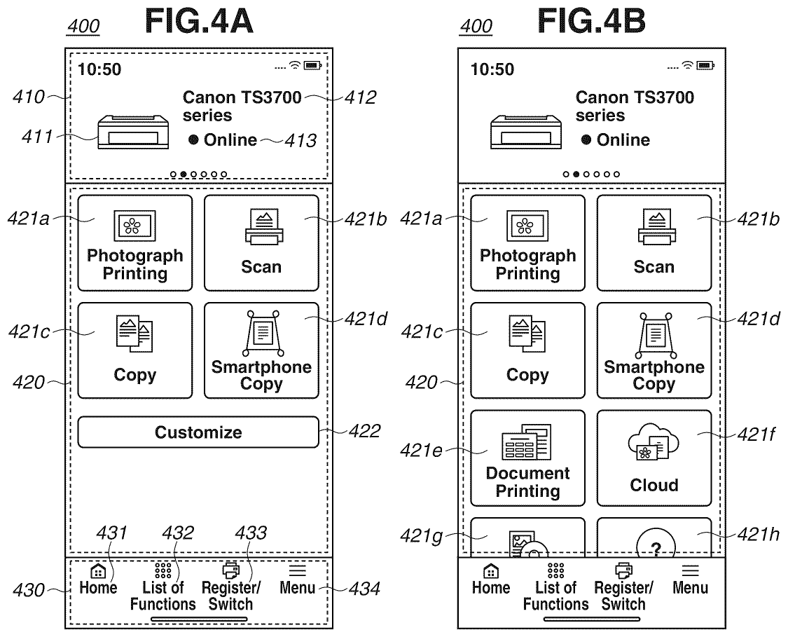

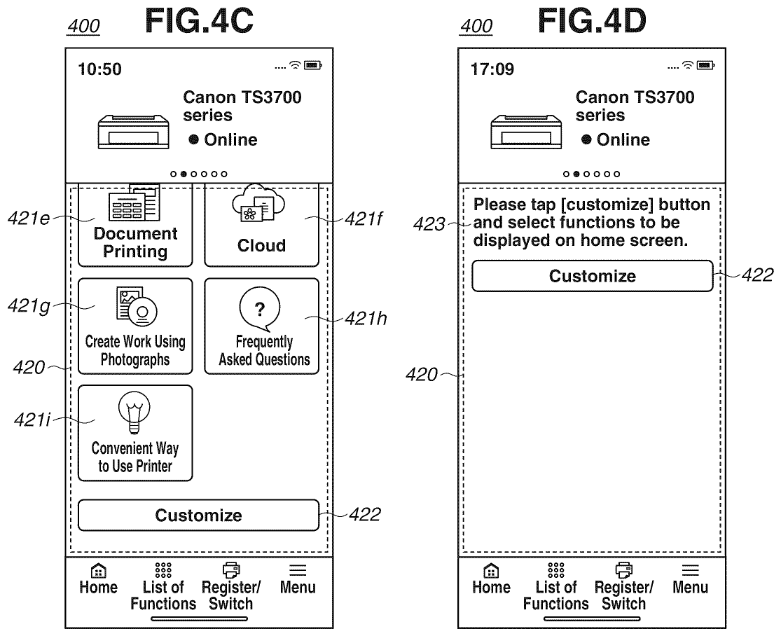

FIGS. 4A to 7 illustrate examples of display of various screens displayed on the display 214 of the electronic device 101 by the application 301.

FIG. 4A is an example of display of a home screen 400 displayed if the application 301 is started. The home screen 400 includes a printer display area 410, a function display area 420, and a tab area 430. Dashed frames illustrated in FIG. 4A indicate the display areas, and are not actually displayed.

The printer display area 410 displays a printer icon 411, printer identification information 412, and status information 413. The printer icon 411 is a display item such as an image, an icon, or a picture representing the external appearance of a printer registered in the application 301 and set as a current job execution target (hereinafter referred to simply as a “target printer”). For example, the external appearance of the image forming apparatus 104 is displayed. The printer identification information 412 is text information indicating an identifier of the target printer, and a model number, a series name, and a model name of the target printer are displayed. The status information 413 indicates the current state of the target printer. The example of FIG. 4A indicates the state where the target printer is online, i.e., is connected to the electronic device 101 so that the target printer can communicate with the electronic device 101.

The function display area 420 displays function icons 421 for instructing the target printer to execute respective functions (one or more function icons are collectively referred to as “function icons 421”). 0 to a plurality of function icons 421 can be displayed by a customization function. In the example of FIG. 4A, four function icons 421a to 421d are displayed in a list. The function icons 421a to 421d are icons (display items) that receive instructions to execute photograph printing, scan, copy, and smartphone copy, respectively. The photograph printing is the function of transmitting an image to be printed from the electronic device 101 to an electronic device and causing the electronic device to print the image. The scan is the function of saving an image read and obtained by the target printer in the electronic device 101. The copy is the function of causing the target printer to print an image read and obtained by the target printer. The smartphone copy is the function of causing the target printer to print an image captured by a camera (an imaging unit) (not illustrated) of the electronic device 101. Each function icon 421 is touched (hereinafter also referred to as “pressed”), whereby the home screen 400 transitions to a screen at a lower hierarchical level for giving an instruction to execute the corresponding function. An execution button is pressed on the screen at the lower hierarchical level, whereby an instruction to execute the function (an instruction to execute a job) is received, and the job is transmitted to the target printer.

The user can optionally change (customize) which function icons 421 are displayed in the function display area 420 and in which order the function icons 421 are placed. A “customize” button 422 is an operation icon that receives an instruction to transition to a “customize” screen for customizing function icons 421 placed in the function display area 420. The “customize” button 422 is displayed in an arrangement after the function icons 421 in the function display area 420.

This is because the main function of the application 301 is to provide instructions to execute functions using the function icons 421, and the customization function is not the main function. It is assumed that after the user customizes function icons 421 in any arrangement by performing customization once, and if the user likes this arrangement, the user provides instructions to execute the functions using the various function icons 421 multiple times by maintaining the arrangement. That is, it is assumed that the “customize” button 422 is used less frequently than the function icons 421. Thus, in the function display area 420, the function icons 421 are displayed in an arrangement before the “customize” button 422 and the “customize” button 422 is placed at a position in order after the arrangement of the function icons 421 so that the function icons 421 are easily operated in priority to the “customize” button 422.

The tab area 430 displays tab icons 431 to 434 that receive instructions to execute functions different from instructions to execute jobs to the target printer. The tab icon 431 is an operation item that receives an instruction to transition to the home screen 400. The tab icon 432 is an operation item that receives an instruction to display a list of functions. The tab icon 433 receives an instruction to display a screen for newly registering a printer in the application 301 or switching the target printer from among a plurality of registered printers. The tab icon 434 is an operation icon that receives an instruction to display a settings menu screen for the application 301.

If the number of function icons 421 placed in the function display area 420 by customization is great (greater than or equal to a predetermined number), not all the items are displayed at a time in the function display area 420. All the placed function icons 421 can be viewed by scrolling the home screen 400. FIG. 4B is an example of display before scrolling in a case where nine function icons 421a to 421i are placed (the display state of the home screen 400 at the time when the home screen 400 starts to be displayed). The function display area 420 displays the eight function icons 421a to 421h that are some of the nine function icons 421a to 421i placed by customization. Among the function icons 421a to 421h, the function icons 421g and 421h are partially displayed. In the example of display in FIG. 4B before scrolling, the function icon 421i and the “customize” button 422 are not displayed.

FIG. 4C is an example of display in a case where a scrolling operation (an operation of keeping touching the display 214 and moving the touch position) is received in the state of FIG. 4B, the home screen 400 is scrolled upward, and function items placed on the lower side are displayed. In FIG. 4C after the scrolling, the function icon 421i and the “customize” button 422 are displayed.

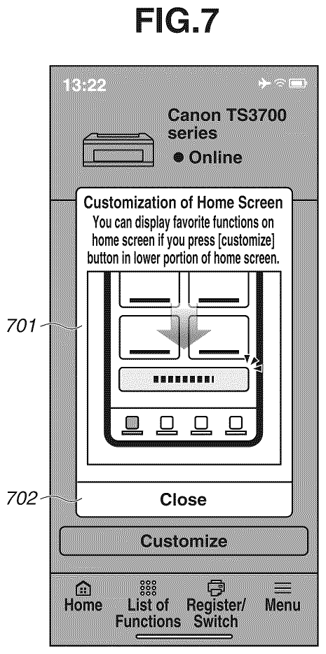

As described above, if the number of function icons 421 placed in the function display area 420 is great, the “customize” button 422 is not displayed at first (in the state where the home screen 400 is not scrolled). Thus, there is a possibility that the user is unaware of the existence of the “customize” button 422 and unaware that the user can customize function icons 421 displayed in the function display area 420. Thus, according to the state where an event where the home screen 400 is displayed but the “customize” button 422 is not operated continues several times (continues a predetermined number of times), display that notifies the user that customization can be performed using the “customize” button 422 (FIG. 7) is performed. The details of this process will be described below.

FIG. 4D illustrates an example of display in a case where the number of function icons 421 placed in the function display area 420 by customization is 0. As described above, customization for displaying (placing) no function icon 421 in the function display area 420 is also possible. In this case, the customization is performed by tapping the “customize” button 422 (an operation of touching and releasing the “customize” button 422), and a notification message 423 that urges the user to place function icons 421 in the function display area 420 of the home screen 400 is displayed. The notification message 423 is a message indicating that function icons 421 can be additionally placed in the function display area 420 of the home screen 400 based on a user operation. The notification message 423 is displayed in a case where the number of function icons 421 placed in the function display area 420 is 0. The notification message 423 is not displayed in a case where the number of function icons 421 is one or more. The “customize” button 422 is displayed immediately below the notification message 423.

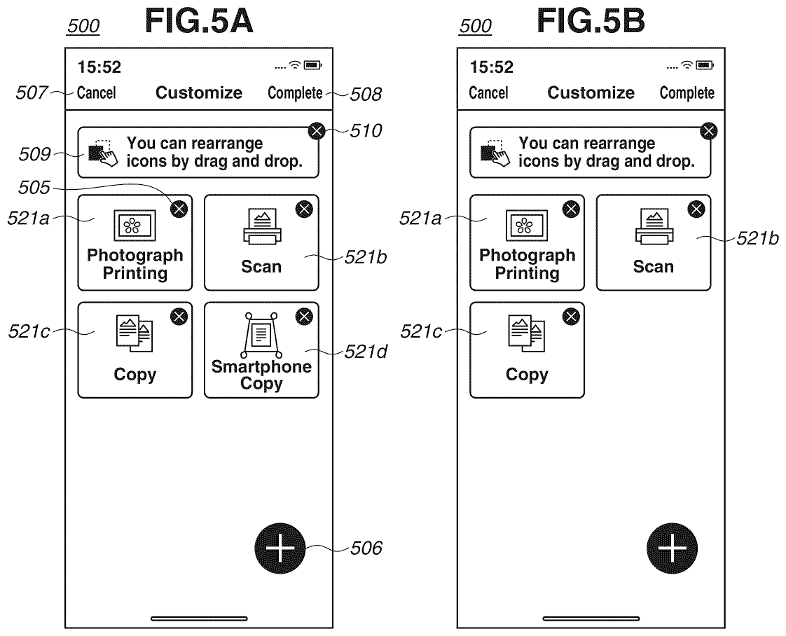

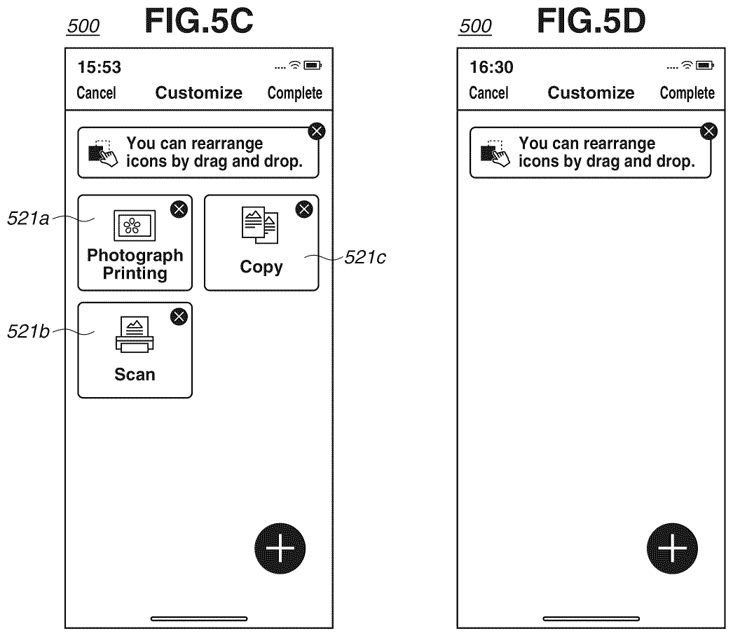

FIG. 5A illustrates an example of display of a “customize” screen 500 displayed in a case where the “customize” button 422 is pressed. FIG. 5A is an example of display of the “customize” screen 500 displayed in a case where the “customize” button 422 is pressed in the state of FIG. 4A. A guide 509 displays a message “you can rearrange icons by drag and drop”. This indicates that the user drags and drops function icons 521 placed on the “customize” screen 500 and thereby can rearrange the placement of the function icons 521. If a button 510 is touched, the guide 509 is hidden. Even if the “customize” screen 500 ends once and a transition is made to the “customize” screen 500 again, the guide 509 is not displayed.

Function icons 521a to 521d displayed on the “customize” screen 500 in FIG. 5A indicate at which positions function icons 421 are displayed on the home screen 400, and correspond to the function icons 421a to 421d, respectively, in FIG. 4A. Even if any of the function icons 521 displayed on the “customize” screen 500 is pressed, the “customize” screen 500 does not transition to a screen for executing a function such as the photograph printing or the scan. If a “cancel” button 507 is pressed, the current customization information is returned to the state before editing, and the “customize” screen 500 transitions to the home screen 400. If a “complete” button 508 is pressed, the current customization information is saved via the customization information management section 307, the “customize” screen 500 transitions to the home screen 400, and the home screen 400 reflects the saved customization information. An “add” button 506 is an operation icon for displaying an addition function selection screen for selecting function icons 521 to be additionally placed.

At the upper right of each of the function icons 521 displayed on the “customize” screen 500, a “delete” icon 505 is displayed. If any of the “delete” icons 505 is pressed, the corresponding function icon 521 is hidden, and a setting is made so that the corresponding function icons 421 is not placed (not displayed) on the home screen 400. In the example of FIG. 5A, if the “delete” icon 505 attached to the function icon 521d is pressed, the function icon 521d is deleted and hidden, and the “customize” screen 500 transitions to an example of display in FIG. 5B.

If a predetermined time (about a second) elapses in the state where any of the function icons 521 displayed on the “customize” screen 500, e.g., any of the function icons 521a to 521c displayed in FIG. 5B, is touched and the touch position remains unmoving, the function icon 521 enters a dragged state. By moving the touch position in the dragged state, it is possible to move the touched function icon 521 by following the touch position. If the function icon 521 is dragged and moved to the position of another function icon 521 and the touch is released, the touch changes to drop, and the dragged function icon 521 is placed at the drop position (the position where the touch is released). The function icon 521 originally placed at the drop position and function icons 521 placed after the function icon 521 in order each move down one position in the placement order. In FIG. 5B, if the function icon 521c is dragged and dropped at the position of the function icon 521b in FIG. 5B, the positions of the function icons 521b and 521c switch, and the “customize” screen 500 enters the state illustrated in FIG. 5C.

FIG. 5D is an example of display in a case where all the function icons 521 are deleted on the “customize” screen 500. If all the function icons 521 are deleted by pressing the “delete” icons 505, the “customize” screen 500 enters the state of FIG. 5D.

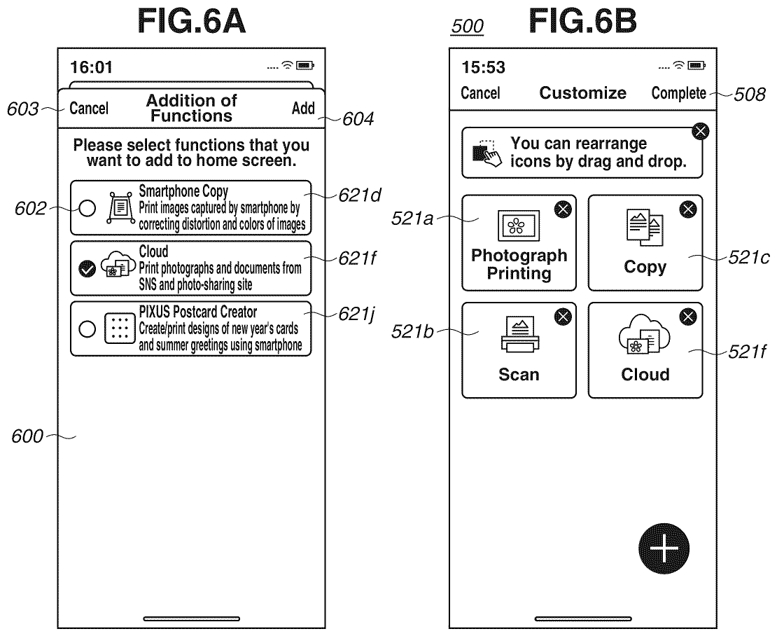

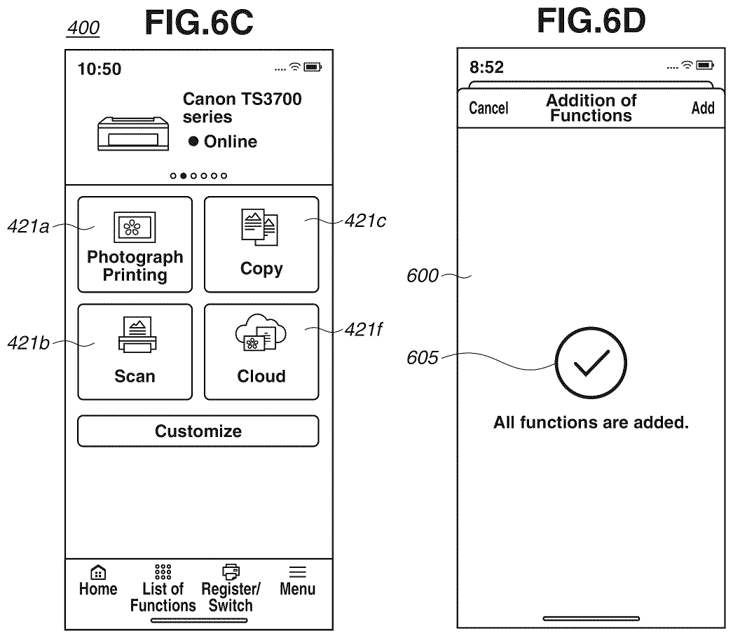

FIG. 6A illustrates an example of display of an addition function selection screen 600 displayed according to the pressing of the “add” button 506 displayed on the “customize” screen 500. The addition function selection screen 600 is displayed in a superimposed manner on the “customize” screen 500. Options 621d, 621f, and 621j are options for functions to be added, and an option corresponding to a function icon that is not placed at the time immediately before the addition function selection screen 600 is displayed is displayed. An option corresponding to a function icon 421 (a function icon 521) placed at the time immediately before the addition function selection screen 600 is displayed is not displayed. In each of the options 621d, 621f, and 621j, a checkbox 602 is displayed. Any of the options 621d, 621f, and 621j is touched, whereby the display and hiding of the check in the checkbox 602 of the touched option switch. Any of the options 621d, 621f, and 621j is checked, whereby the option can be selected as a target to be added. The checked option is unchecked by touching the option again, whereby the selection of the option can be cleared, and the option can be removed from addition targets. If a “cancel” button 603 is pressed, the addition function selection screen 600 transitions to the “customize” screen 500 without adding functions. If at least one of the checkboxes 602 of options for functions to be added that are displayed on the addition function selection screen 600 (the options 621d, 621f, and 621j in the example of FIG. 6A) is checked, an “add” button 604 is displayed in an active state. In the state where none of the checkboxes 602 is checked, since an addition target is not present, the “add” button 604 is displayed in an inactive state. Even if the “add” button 604 in the inactive state is touched, the addition function selection screen 600 does not transition to the “customize” screen 500. If the “add” button 604 in the active state is touched, the addition function selection screen 600 transitions to the “customize” screen 500, and the “customize” screen 500 that displays a function icon 521 corresponding to an option in a selected state on the addition function selection screen 600 is displayed. For example, if the “add” button 506 is pressed in the state of FIG. 5C, and the addition function selection screen 600 in FIG. 6A is displayed, and the option 621f is selected as an addition target, and the “add” button 604 is pressed, the “customize” screen 500 illustrated in FIG. 6B is displayed. In FIG. 6B, a function icon 521f corresponding to the option 621f selected in FIG. 6A is added to FIG. 5C. If the “complete” button 508 is pressed in the state of FIG. 6C, the home screen 400 in FIG. 6C is displayed. To the home screen 400, a function icon 421f corresponding to the option 621f selected in FIG. 6A is added.

If function icons for all functions that can be placed on the “customize” screen 500 are placed at the time immediately before the addition function selection screen 600 is displayed, an option for a function to be added is not displayed on the addition function selection screen 600. In this case, the addition function selection screen 600 as illustrated in FIG. 6D is displayed. In FIG. 6D, a guide 605 including descriptive text indicating that all the functions are displayed is displayed. In this case, the “add” button 604 is inactive, and only the “cancel” button 603 can be pressed.

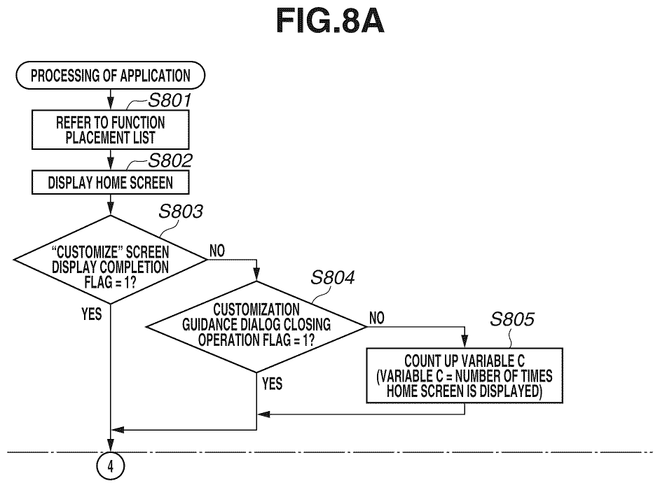

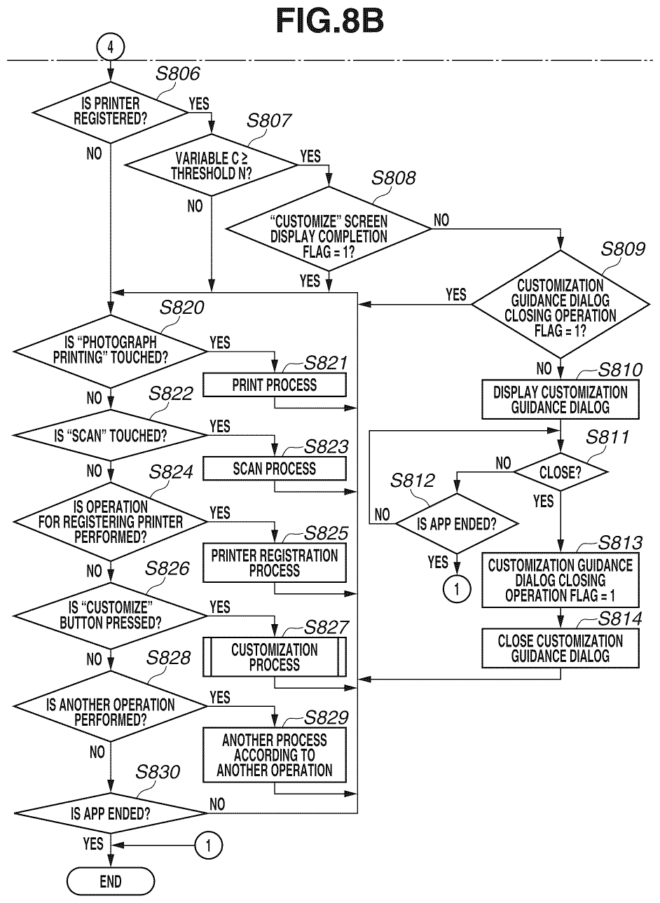

FIGS. 8A to 8B illustrate a flowchart of the processing of the application 301. Processes in this flowchart are achieved by the CPU 202 loading a program stored in the ROM 203 into the RAM 204 and executing the program. In the state where the electronic device 101 is started, if an operation of providing an instruction to start the application 301 by tapping the application 301 in a list of apps installed on the electronic device 101 or on the home screen 400, the processing in FIGS. 8A to 8B are started. Even if the application 301 is closed, the storage of the following variables and flags stored in the storage device 209 is maintained. That is, even if the application 301 ends and is re-started, the previous values are used.

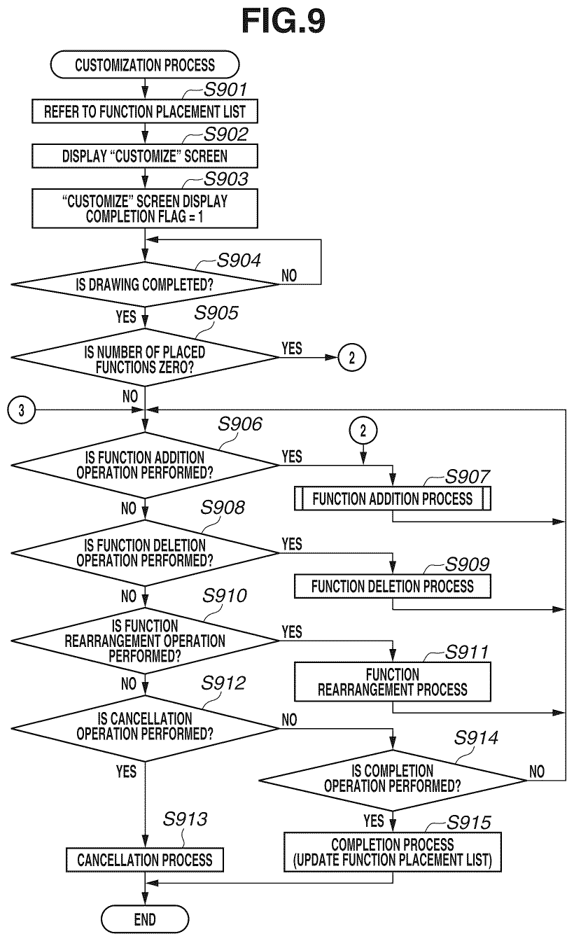

In step S801, the CPU 202 acquires a function placement list stored in the storage device 209. The function placement list is information indicating the placement of a function icon group (the order and the positions of placed icons) customized by the user performing processing on the “customize” screen 500 described above with reference to FIGS. 5A to 5D, 6A and 6B. The processing on the “customize” screen 500 will be described below with reference to FIG. 9. In step S801, the CPU 202 also acquires information regarding a printer connected to the electronic device 101 on which a content to be displayed in the printer display area 410 is based.

In step S802, the CPU 202 displays the home screen 400. At this time, the function display area 420 displays function icons 421 for instructing the target printer to execute respective functions in an order (a placement) indicated by the function placement list acquired in step S801. If function icons 421 have not been customized, the function icons 421 are displayed in a default placement. For example, FIG. 5A illustrates an example of display at this time. If no printer is registered in the application 301, no function icon 421 is displayed in the function display area 420, regardless of the function placement list. Even if a printer is registered in the application 301, if the function placement list is information indicating that no function icon 421 is displayed (if the function placement list is customized in this manner), no function icon 421 is displayed in the function display area 420.

The function placement list is stored in association with each target printer. That is, if two printers, namely a printer A and a printer B, are registered, a function placement list A corresponding to the printer A and a function placement list B corresponding to the printer B are stored as the function placement list. If the target printer is the printer A, the home screen 400 where a function icon group is placed in a placement based on the function placement list A corresponding to the printer A is displayed. If the target printer is the printer B, the home screen 400 where a function icon group is placed in a placement based on the function placement list B corresponding to the printer B is displayed. The function placement lists A and B can be customized to indicate different functions and different placements. In a customization process, a function placement list corresponding to a printer that is currently the target printer is customized. The target printer can be switched by sliding the target printer (an operation of keeping touching the target printer and moving the touch position) to the right or the left in the printer display area 410.

In step S803, the CPU 202 refers to a “customize” screen display completion flag stored in the storage device 209 and determines whether the “customize” screen display completion flag is 1. The “customize” screen display completion flag is information indicating whether the “customize” screen 500 has been displayed by a user operation. If the “customize” screen 500 has been displayed, the “customize” screen display completion flag is 1. If the “customize” screen 500 has not been displayed, the “customize” screen display completion flag is 0. The initial value of the “customize” screen display completion flag is 0 when the application 301 is installed on the electronic device 101. If the “customize” screen display completion flag is 1 (Yes in step S803), the processing proceeds to step S806. If not (No in step S803), the processing proceeds to step S804.

In step S804, the CPU 202 determines whether a customization guidance dialog closing operation flag=1. The customization guidance dialog closing operation flag is a flag indicating whether a user operation of closing a customization guidance dialog displayed in step S810 has been performed. If the operation of closing the customization guidance dialog has been performed, the customization guidance dialog closing operation flag is 1. If the operation of closing the customization guidance dialog has not been performed, the customization guidance dialog closing operation flag is 0. If the customization guidance dialog closing operation flag=1 (Yes in step S804), the processing proceeds to step S806. If not (if the customization guidance dialog closing operation flag=0) (No in step S804), the processing proceeds to step S805.

In step S805, the CPU 202 adds 1 to the value of a variable C stored in the storage device 209 (increments the value of the variable C by 1). The variable C is a variable indicating the number of times the home screen 400 is displayed (the application 301 is started) without displaying the “customize” screen 500 (i.e., in the state where the “customize” screen display completion flag=0).

In step S806, the CPU 202 determines whether a printer is registered in the application 301. If a printer is not registered, no function icon 421 is displayed in the function display area 420. In this case, it is not necessary to display the customization guidance dialog for guiding the user to the “customize” screen 500. Thus, if the determination is No in step S806, the processing does not proceed to step S810. If a printer is registered (Yes in step S806), the processing proceeds to step S807. If not (No in step S806), the processing proceeds to step S820.

In step S807, the CPU 202 determines whether the variable C stored in the storage device 209 is greater than or equal to a threshold N. The threshold N is a constant determined in advance and is, for example, 3. If the variable C is greater than or equal to the threshold N (Yes in step S807), the processing proceeds to step S808. If not (No in step S807), the processing proceeds to step S820.

In step S809, the CPU 202 determines whether the customization guidance dialog closing operation flag=1. This determination is similar to that in step S804. If the customization guidance dialog closing operation flag is 1 (Yes in step S809), the processing proceeds to step S820. If not (if the customization guidance dialog closing operation flag is 0) (No in step S809), the processing proceeds to step S810.

In step S810, the CPU 202 displays the customization guidance dialog on the display 214. While the description is provided on the assumption that the customization guidance dialog is displayed in a superimposed manner on a layer above the home screen 400 displayed in step S802, the customization guidance dialog may be displayed by switching from the home screen 400 to the customization guidance dialog.

FIG. 7 illustrates an example of display of the customization guidance dialog. A customization guidance dialog 701 is displayed in a superimposed manner on the home screen 400. To enable the user to recognize that the customization guidance dialog 701 is active and the home screen 400 is inactive, a portion other than the customization guidance dialog 701 (a portion of the home screen 400) is grayed out. The customization guidance dialog 701 is a guidance that notifies the user that function icons 421 placed on the home screen 400 can be customized by pressing the “customize” button 422. More specifically, the customization guidance dialog 701 is a guidance that notifies the user that an item that is to be placed on the home screen 400 can be added, and the position of the added item can be changed. The customization guidance dialog 701 displays a message “you can display favorite functions on home screen if you press [customize] button in lower portion of home screen”. The customization guidance dialog 701 also displays a picture visually illustrating the placement of the “customize” button 422 after the arrangement of function icons 421. That is, the customization guidance dialog 701 includes a content indicating the position of the “customize” button 422. That is, the customization guidance dialog 701 indicates that customization for adding an item to the home screen 400 can be performed (the description of the content of the customization function) and an operation method for the customization. As the operation method for the customization, specifically, the customization guidance dialog 701 indicates an operation method for displaying the “customize” screen 500 by pressing the “customize” button 422 placed after the arrangement of function icons 421 (in a lower portion of the home screen 400). The above contents of the guide displayed in the customization guidance dialog 701 are merely examples. While the guide includes a plurality of contents in the description, the guide is not limited to the guide including all the contents, and the guide may include any one or more of the above contents. The customization guidance dialog 701 also displays a “close” button 702 for closing the customization guidance dialog 701.

In step S811, the CPU 202 determines whether the “close” button 702 is pressed.

If the “close” button 702 is pressed (Yes in step S811), the processing proceeds to step S813. If not (No in step S811), the processing proceeds to step S812.

In step S812, the CPU 202 determines whether the application 301 is closed. If the application 301 is closed by an operation of closing the application 301 or an operation of powering off the electronic device 101 (Yes in step S812), the processing in FIGS. 8A to 8B ends. If not (No in step S812), the processing proceeds to step S813. If the application 301 ends and then restarts, since the “close” button 702 is not operated, a determination similar to the determination described above in FIGS. 8A to 8B is made, and the customization guidance dialog 701 is displayed again. Even if the application 301 is caused to transition to the background in the state where the customization guidance dialog 701 is displayed, and then, the application 301 transitions to the foreground, this is not counted as the execution of the operation of closing the customization guidance dialog 701.

In step S813, the CPU 202 sets the value of the customization guidance dialog closing operation flag stored in the storage device 209 to 1. That is, the CPU 202 stores the state where the operation of closing the customization guidance dialog 701 has been performed.

In step S814, the CPU 202 closes the customization guidance dialog 701. That is, the CPU 202 hides the customization guidance dialog 701 and displays the home screen 400 in an active state where the graying out is cancelled.

In steps S820 to S828, processes according to operations on various operation items (display items) displayed on the home screen 400 are performed. Regarding a function icon 421 that is not displayed by customization, it is determined that the function icon 421 is not operated in the following operation determination step.

In step S820, the CPU 202 determines whether the function icon 421a for the photograph printing is touched (pressed). If it is determined that the function icon 421a is touched (Yes in step S820), the processing proceeds to step S821. If not (No in step S820), the processing proceeds to step S822. In step S821, the CPU 202 performs control to execute a print process for the photograph printing according to an operation. Specifically, the CPU 202 displays an image selection screen that displays candidates for images to be printed. If the CPU 202 receives the selection of any of the images, the CPU 202 displays a print settings screen. Then, the CPU 202 receives an operation of making print settings (a printing sheet, the number of images to be printed, and the setting of whether printing is performed in color or monochrome) from the user on the print settings screen. Then, if a print icon displayed on the screen is pressed, the CPU 202 transmits a print job for printing the selected image with the made print settings to the target printer. The target printer having received the print job (e.g., the image forming apparatus 104) executes printing based on the received print job.

In step S822, the CPU 202 determines whether the function icon 421b for the scan is touched (pressed). If it is determined that the function icon 421b is touched (Yes in step S822), the processing proceeds to step S823. If not (No in step S822), the processing proceeds to step S824. In step S823, the CPU 202 performs control to execute a scan process according to an operation. Specifically, the CPU 202 displays a scan settings screen and receives an operation of making scan settings (a scan target sheet, the setting of whether scanning is performed in color or monochrome, the resolution, and the save location) from the user. Then, if a scan execution icon displayed on the screen is pressed, the CPU 202 transmits a scan job for scanning with the made scan settings to the target printer. The target printer having received the scan job (e.g., the image forming apparatus 104) scans a document (reads a document using a reading unit) based on the received scan job, and generates, saves, and transfers a scanned image.

In step S824, the CPU 202 determines whether an operation for registering a printer in the application 301 is performed in the tab area 430. If the operation for registering a printer is performed (Yes in step S824), the processing proceeds to step S825. If not (No in step S824), the processing proceeds to step S826. In step S825, the CPU 202 executes a registration process for registering a printer in the application 301 according to the operation. If a new printer is registered, the CPU 202 also generates a function placement list corresponding to the new printer (information indicating a placement is a default initial value) and records the function placement list in the storage device 209.

In step S826, the CPU 202 determines whether the “customize” button 422 is pressed. If the “customize” button 422 is pressed (if an operation of starting customization is received) (Yes in step S826), the processing proceeds to step S827. If not (No in step S826), the processing proceeds to step S828. In step S827, the CPU 202 performs a customization process. The customization process will be described below with reference to FIG. 9.

In step S828, the CPU 202 determines whether another operation on the application 301 is performed. If another operation is performed (Yes in step S828), the processing proceeds to step S829. If not (No in step S828), the processing proceeds to step S830. In step S829, the CPU 202 performs another process according to another operation. For example, the CPU 202 performs a copy process according to the pressing of the function icon 421c for the copy.

In step S830, the CPU 202 determines whether an operation of closing (ending) the application 301 is performed. If the operation of closing the application 301 is performed (Yes in step S830), the processing in FIGS. 8A to 8B ends. If not (No in step S830), the processing returns to step S820. Then, the processing is repeated.

FIG. 9 illustrates a flowchart of the customization process by the application 301. This processing is the details of the process of step S827 in FIG. 8B. Processes in this flowchart are achieved by the CPU 202 loading a program stored in the ROM 203 into the RAM 204 and executing the program.

In step S901, the CPU 202 refers to the function placement list corresponding to the current target printer stored in the storage device 209.

In step S902, the CPU 202 displays the “customize” screen 500 where a plurality of function icons 521 is placed in a placement based on the function placement list referred to in step S901. FIG. 5A illustrates an example of display of the “customize” screen 500. The display contents of the “customize” screen 500 in FIG. 5A are as described above.

In step S903, the CPU 202 sets the “customize” screen display completion flag stored in the storage device 209 to 1 and records the “customize” screen display completion flag. As described above, if the “customize” screen 500 is displayed once, the completion of the display of the “customize” screen 500 is stored. Thus, from the next time onward, even if the application 301 is started, the customization guidance dialog 701 is not displayed. This prevents the display of the customization guidance dialog 701 to a user who has viewed the “customize” screen 500 and is aware that customization can be performed, which is a process cumbersome for the user.

In step S904, the CPU 202 determines whether a display process (a drawing process) on the “customize” screen 500 is completed. If it is determined that the drawing of the “customize” screen 500 is completed (Yes in step S904), the processing proceeds to step S905. If not (No in step S904), the CPU 202 waits for the drawing of the “customize” screen 500 to be completed. In addition, the CPU 202 may wait a predetermined time (about a second) after the drawing of the “customize” screen 500 is completed. Then, the processing proceeds to step S905. If it is determined in step S905 that the number of placed functions is zero, the “customize” screen 500 automatically transitions from the display state where the number of placed functions illustrated in FIG. 5D is zero to the addition function selection screen 600. The automatic transition means that the “customize” screen 500 is displayed and then transitions without receiving an operation from the user. At this time, the CPU 202 waits until the “customize” screen 500 is completely drawn (completely displayed) once, and then, an automatic transition is made in the processes of step S907 and subsequent steps after the determination is Yes in step S905. This is to reduce the user's confusion about the automatic screen transition. That is, the user is caused to recognize a normal screen transition in which the “customize” screen 500 is displayed once, and the user is also caused to recognize that the state where the number of placed functions is zero is the reason for the automatic transition.

In step S905, the CPU 202 determines whether the function placement list referred to in step S901 indicates that the number of function icons placed on the home screen is zero (function icons are in the state of FIG. 4D or 5D). If the number of placed functions is zero (Yes in step S905), the processing proceeds to step S907. In step S907, the CPU 202 performs a function addition process. This causes the “customize” screen 500 to automatically transition from the display state where the number of placed functions is zero illustrated in FIG. 5D to the addition function selection screen 600. If the number of placed functions is not zero (is one or more) (No in step S905), the processing proceeds to step S906.

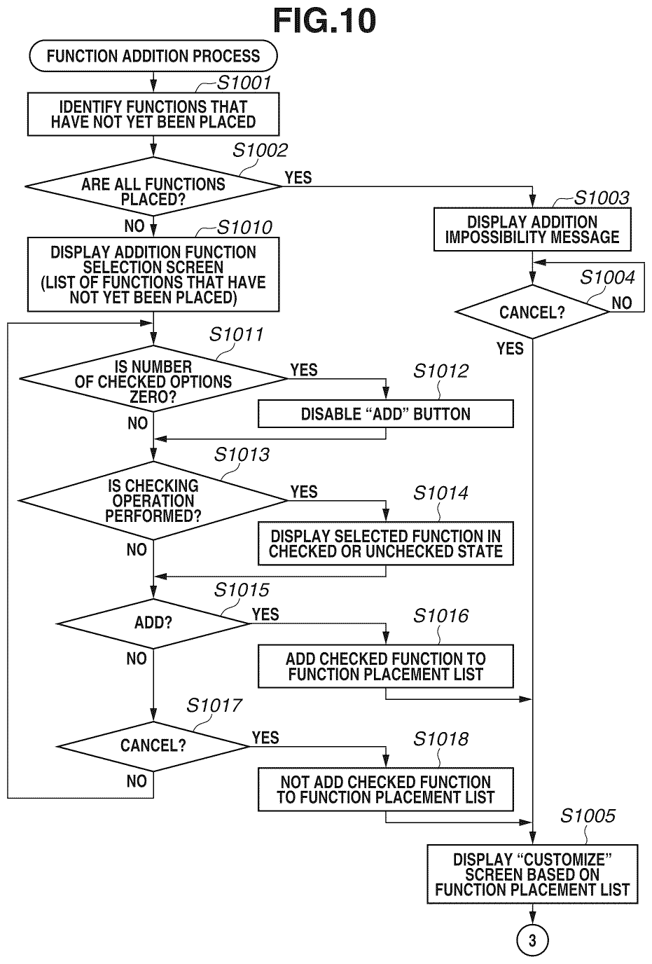

In step S906, the CPU 202 determines whether a function addition operation is performed (the “add” button 506 is pressed) on the “customize” screen 500. If the function addition operation is performed (Yes in step S906), the processing proceeds to step S907. If not (No in step S906), the processing proceeds to step S908. In step S907, the CPU 202 performs the function addition process. The details of this process will be described below with reference to FIG. 10.

In step S908, the CPU 202 determines whether a function deletion operation (an item deletion operation) is performed. The function deletion operation is an operation of pressing the “delete” icon 505 attached to any of the function icons 521. If the function deletion operation is performed (Yes in step S908), the processing proceeds to step S909. If not (No in step S908), the processing proceeds to step S910. In step S909, the CPU 202 deletes the function icon 521 corresponding to the pressed “delete” icon 505. More specifically, the CPU 202 hides the function icon 521 deleted from the “customize” screen 500 and moves up function icons 521 placed after the function icon 521 corresponding to the pressed “delete” icon 505 in the placement order. The CPU 202 also reflects the content of the function deletion operation on the function placement list stored in the storage device 209 and stores the updated function placement list in the RAM 204. That is, the CPU 202 deletes the function icon 521 corresponding to the pressed “delete” icon 505 from the list and stores the function placement list having a content in which the function icons 521 placed after the function icon 521 are moved up in the placement order in the RAM 204. To deal with a cancellation operation, the CPU 202 also stores the function placement list stored in the storage device 209 when the “customize” screen 500 starts to be displayed (the function placement list before the update).

In step S910, the CPU 202 determines whether a function rearrangement operation is performed. The function rearrangement operation is a drag-and-drop operation on a function icon 521 as described above with reference to FIGS. 5B and 5C. If the function rearrangement operation is performed (Yes in step S910), the processing proceeds to step S911. If not (No in step S910), the processing proceeds to step S912. In step S912, the CPU 202 changes the placement of the function icons 521 displayed on the “customize” screen 500 in the order rearranged by the function rearrangement operation. The CPU 202 also reflects the content of the function rearrangement operation on the function placement list stored in the storage device 209 and stores the function placement list updated to indicate the order rearranged by the function rearrangement operation in the RAM 204. To deal with a cancellation operation, the CPU 202 also stores the function placement list stored in the storage device 209 when the “customize” screen 500 starts to be displayed (the function placement list before the update).

In step S912, the CPU 202 determines whether a cancellation operation is performed (the “cancel” button 507 is pressed). If the cancellation operation is performed (Yes in step S912), the processing proceeds to step S913. If not (No in step S912), the processing proceeds to step S914. In step S913, the CPU 202 performs a cancellation process. Then, the processing in FIG. 9 ends. The CPU 202 returns to the display of the home screen 400. Specifically, the CPU 202 discards the updated function placement list stored in the RAM 204. That is, the CPU 202 discards the contents updated by performing the processes of steps S906 to S911 after the “customize” screen 500 starts to be displayed. Consequently, the contents of the function placement list before the update before the processes of steps S906 to S911 are performed when the “customize” screen 500 starts to be displayed are stored in the storage device 209. The CPU 202 also displays the home screen 400 where function icons 421 are placed with the contents of the function placement list before the update. Then, the processing returns to FIG. 8B.

In step S914, the CPU 202 determines whether a completion operation is performed (the “complete” button 508 is pressed). If the completion operation is performed (Yes in step S914), the processing proceeds to step S915. If not (No in step S914), the processing returns to step S906. In step S906, the CPU 202 waits for an operation of the user. In step S915, the CPU 202 performs a completion process, and the processing in FIG. 9 ends. Specifically, the CPU 202 records the updated function placement list stored in the RAM 204 in the storage device 209. That is, the CPU 202 updates the function placement list stored in the storage device 209 with the contents updated by performing the processes of steps S906 to S911 after the “customize” screen 500 starts to be displayed. The CPU 202 also displays the home screen 400 where function icons 421 are placed with the contents of the updated function placement list. Then, the processing returns to FIG. 8B.

FIG. 10 illustrates a flowchart of the function addition process by the application 301. This processing is the details of the process of step S907 in FIG. 9. Processes in this flowchart are achieved by the CPU 202 loading a program stored in the ROM 203 into the RAM 204 and executing the program.

In step S1001, the CPU 202 refers to the function placement list and identifies functions that have not yet been placed. The function placement list referred to in this step is the function placement list updated according to the processes of steps S906 to S911 if the processes are performed, and stored in the RAM 204. The function placement list referred to in this step may also be the function placement list stored in the storage device 209 if it is before the processes of steps S906 to S911 are performed. The functions that have not yet been placed are functions other than functions of which the placement on the home screen 400 is indicated by the referred function placement list from among all functions that can be placed on the home screen 400.

In step S1002, the CPU 202 determines whether all the functions are placed (i.e., the number of functions that have not yet been placed and are identified in step S1001 is zero). If all the functions are placed (Yes in step S1002), the processing proceeds to step S1003. If not (No in step S1002), the processing proceeds to step S1010. In step $1003, since there is no more function that can be added, the CPU 202 displays an addition impossibility message. An example of display in step S1003 is an example of display illustrated in FIG. 6D, and the displayed content is as described above. In step S1004, the CPU 202 determines whether the “cancel” button 603 is pressed. If the “cancel” button 603 is not pressed (No in step S1004), the CPU 202 waits for the “cancel” button 603 to be pressed. If the “cancel” button 603 is pressed (Yes in step S1004), the processing proceeds to step S1005. In step S1005, the CPU 202 displays the “customize” screen 500 based on the function placement list. Then, the processing proceeds to step S906 in FIG. 9.

In step S1010, the CPU 202 displays the addition function selection screen 600 and displays the functions that have not yet been placed and are identified in step S1001 as options in a list. An example of display at this time is described above with reference to FIG. 6A. In an initial state, since none of the functions that have not yet been placed is selected, none of the checkboxes 602 is checked, and the “add” button 604 is in the inactive state.

In step S1011, the CPU 202 determines whether the number of checked options is zero (i.e., none of the options is selected) from among the options (the functions that have not yet been placed) displayed on the addition function selection screen 600. If the number of checked options is zero (Yes in step S1011), the processing proceeds to step S1012. If not (No in step S1011), the processing proceeds to step S1013. In step S1012, the CPU 202 displays the “add” button 604 in the inactive state. If an operation of checking any of the options once and then unchecking the option (an operation of clearing the selection of the option) is performed, then in step S1012, the “add” button 604 is changed from the active display form to the inactive display form.

In step S1013, the CPU 202 determines whether a checking operation for selecting (pressing) any of the options (the functions that have not yet been placed) displayed on the addition function selection screen 600 is performed.

If the checking operation is performed (Yes in step S1013), the processing proceeds to step S1014. If not (No in step S1013), the processing proceeds to step S1015. In step S1014, the CPU 202 changes the checked state of the checkbox 602 of the option on which the checking operation is performed. That is, if the checking operation is performed in the state where the checkbox 602 is checked, the CPU 202 unchecks the checkbox 602 and changes the option to the display state where the option is not selected (hides the check mark). If the checking operation is performed in the state where the checkbox 602 is not checked, the CPU 202 checks the checkbox 602 and changes the option to the display state where the option is selected (displays the check mark). If the number of checked options changes from 0 to 1 by this operation, the CPU 202 changes the display state of the “add” button 604 from the inactive state (e.g., the display of gray characters) to the active state (e.g., the display of black characters).

In step S1015, the CPU 202 determines whether the “add” button 604 is pressed.

If the “add” button 604 is pressed (Yes in step S1015), the processing proceeds to step S1016. If not (No in step S1015), the processing proceeds to step S1017. In step S1016, the CPU 202 adds a function of which the checkbox 602 is checked to the function placement list. Then, in step S1005, the CPU 202 displays the “customize” screen 500 where a function icon 521 is placed on the “customize” screen 500 based on the function placement list to which the function is added in step S1016. Then, the processing proceeds to step S906 in FIG. 9. In this manner, a function icon 421 corresponding to the function added in step S1016 is added to the home screen 400.

In step S1017, the CPU 202 determines whether the “cancel” button 603 is pressed. If the “cancel” button 603 is pressed (Yes in step S1017), the processing proceeds to step S1018. If not (No in step S1017), the processing returns to step S1011. In step S1011, the CPU 202 waits for an operation of the user. In step S1018, the CPU 202 does not add the function of which the checkbox 602 is checked to the function placement list. Then, in step S1005, the CPU 202 displays the “customize” screen 500 where a function icon 521 is placed on the “customize” screen 500 based on the function placement list before the addition function selection screen 600 is displayed. Then, the processing proceeds to step S906 in FIG. 9.

As described above, according to the present exemplary embodiment, the “customize” screen 500 is displayed based on the pressing of the “customize” button 422, and the customization function is executed. However, on the assumption that there is also a user unaware that the customization function is executed if the “customize” button 422 is operated, in a case where an event where the home screen 400 is to be displayed occurs, and if a predetermined condition is not satisfied, the home screen 400 is displayed as normal. For example, the event where the home screen 400 is to be displayed is the start of the application 301. However, in a case where the event where the home screen 400 is to be displayed occurs, and if the predetermined condition is satisfied, the CPU 202 displays the customization guidance dialog 701. The predetermined condition is that an event where the home screen 400 is displayed but the “customize” button 422 is not operated continues several times (continues a predetermined number of times). This can prevent the situation where the user continues to use the application 301 without being aware of the existence of the customization function for the home screen 400, and cannot sufficiently utilize the application 301. If, on the other hand, the predetermined condition is not satisfied, the customization guidance dialog 701 is not displayed. If the predetermined condition on the assumption that there is a possibility that the user is unaware of the existence of the customization function is satisfied, the CPU 202 displays the customization guidance dialog 701. Thus, it is also possible to reduce cumbersomeness due to causing a user aware of the existence of the customization function to unnecessarily confirm display or perform an operation, and also prevent an operation from being cumbersome. Since the customization guidance dialog 701 is displayed in a superimposed manner on the home screen 400, if the customization guidance dialog 701 is displayed, a function icon 421 displayed on the home screen 400 is hidden behind the customization guidance dialog 701 and cannot be operated. In contrast, according to the present exemplary embodiment, if the predetermined condition is not satisfied, the customization guidance dialog 701 is not displayed. Thus, it is possible to reduce the situation where operability decreases because a function icon 421 is hidden behind the customization guidance dialog 701 and cannot be operated (the function of the function icon 421 cannot be executed). That is, it is possible to reduce cumbersomeness due to display that guides the user through a function, while also preventing the user from being unaware of the existence of the function. Thus, the user can utilize the function more effectively. While in the present exemplary embodiment an example of a guide regarding the customization function has been described, the present disclosure is applicable to the customization function as well as to a guide regarding another function included in the electronic device 101.

According to the present exemplary embodiment, the user can customize (add or delete) an item placed on the home screen 400 (a first screen) where a plurality of items (function icons 421) can be placed. Then, if a particular operation (the pressing of the “customize” button 422) is performed when the home screen 400 where a deletable item is placed is displayed, a second screen (the “customize” screen 500) that receives an instruction to delete an item is displayed and receives a deletion instruction. If, the particular operation is performed when the home screen 400 where a deletable item is not placed is displayed, the processing proceeds to step S907 after the determination is Yes in step S905. In step S907, a third screen (the addition function selection screen 600) where an item to be additionally placed on the home screen 400 is selected is displayed. Even if the “customize” screen 500 is displayed based on the execution of the particular operation when the home screen 400 where a deletable item is not placed is displayed, an operation of deleting or rearranging an item cannot be performed. That is, there is not a content that can be customized other than the addition of an item. Thus, the user needs to display the addition function selection screen 600 by pressing the “add” button 506. In contrast, in the present exemplary embodiment, if the particular operation is performed when the home screen 400 where a deletable item is not placed is displayed, the processing proceeds to step S907 after the determination is Yes in step S905. In step S907, the addition function selection screen 600 is automatically displayed. Thus, it is possible to save the user the trouble of pressing the “add” button 506. As described above, a different screen transition is adaptively made based on the presence or absence of an item placed on a screen where customization can be performed. Thus, it is possible to perform a customization operation more efficiently with less operation trouble. Thus, it is possible to improve the operability for the user.

The above-described various types of control performed by the CPU 202 may be performed by a single piece of hardware, or the processing of the above-described various types of control may be shared by a plurality of pieces of hardware (e.g., a plurality of processors or circuits), thereby controlling the entirety of the apparatus.

While the present disclosure has been described in detail based on its suitable exemplary embodiments, the present disclosure is not limited to these specific exemplary embodiments. The present disclosure also includes various forms without departing from the spirit and scope of the disclosure. The above exemplary embodiments merely illustrate exemplary embodiments of the present disclosure, and can also be appropriately combined together.

In the above exemplary embodiments, as an example, a case has been described where the present disclosure is applied to the electronic device 101. The present disclosure, however, is not limited to this example, and is applicable to any electronic device that may customize (add or delete by a user operation) a displayed item. That is, the present disclosure is applicable to a personal computer, a tablet terminal, a mobile phone terminal, a mobile image viewer, a printer apparatus including a display, a digital photo frame, a music player, a game apparatus, an electronic book reader, or a household electrical appliance apparatus.

In the above exemplary embodiments, as an example, a case has been described where the present disclosure is applied to a print application for instructing a printer to execute a job (i.e., controlling a printer as an external device). The present disclosure, however, is not limited to the print application. That is, the present disclosure is also applicable to other applications. For example, the present disclosure is also applicable to a control application for an external device, such as an air conditioner control application that operates in a smartphone and is for transmitting various operation instructions to an air conditioner as an external device and controlling the air conditioner. The present disclosure is applicable to an application that also controls a household electrical appliance as an external device, such as a television, a vacuum cleaner, or a lighting instrument, as well as an Internet-of-Things (IoT) device such as a smart speaker.

According to the present disclosure, it is possible to reduce cumbersomeness due to display that guides a user through a function, while also enabling the user to utilize the function more effectively.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-118270, filed Jul. 23, 2024, which is hereby incorporated by reference herein in its entirety.

What is claimed is:

1. An electronic device comprising:
at least one memory storing a program; and
at least one processor, where executing the stored program causes the at least one processor to:
perform a process of displaying a first screen including a predetermined item;
perform control to execute a predetermined function based on an operation on the predetermined item on the first screen;
perform control to display the first screen without displaying a guide regarding the predetermined item when an event where the first screen is to be displayed occurs and in a case where a predetermined condition corresponding to a state where the predetermined item is not operated even in a case where the first screen has been displayed is not satisfied; and
perform control to display the guide when an event where the first screen is to be displayed occurs and in a case where the predetermined condition is satisfied.

2. The electronic device according to claim 1, wherein the predetermined condition includes a condition that an event where the first screen is displayed but the predetermined item is not operated continues a predetermined number of times.

3. The electronic device according to claim 2, wherein the predetermined condition includes a condition that a predetermined operation of closing the display of the guide has not been performed.

4. The electronic device according to claim 3, wherein the predetermined operation does not include an operation of ending application software for displaying the first screen and an operation of causing the application software to operate in a background.

5. The electronic device according to claim 1, wherein the first screen is a screen that displays a plurality of items different from the predetermined item and corresponding to respective functions different from each other.

6. The electronic device according to claim 5, wherein the predetermined item is placed after an arrangement of the plurality of items on the first screen.

7. The electronic device according to claim 6, wherein the predetermined item is not displayed in a case where the first screen starts to be displayed and is displayed by scrolling the first screen.

8. The electronic device according to claim 5, wherein the predetermined function is a customization function for the first screen for performing at least one of addition, deletion, or rearrangement of the plurality of items placed on the first screen based on a user operation.

9. The electronic device according to claim 5, wherein each of the plurality of items is an item for instructing an external device to operate.

10. The electronic device according to claim 9, wherein the external device is a printer, and the plurality of items includes at least one of printing, scan, or copy.

11. The electronic device according to claim 5, wherein the processor is further caused to perform control to, in a case where the first screen where the plurality of items is placed is displayed and in a case where an operation on the predetermined item is received, display a second screen that receives an instruction to delete an item so that an item placed on the first screen is not displayed on the first screen, and perform control to, in a case where the first screen where the plurality of items is not placed is displayed and in a case where an operation on the predetermined item is received, display a third screen that receives an instruction to select an item to be additionally placed on the first screen.

12. The electronic device according to claim 1, wherein the guide indicates at least one of a content of the predetermined function, an operation method for executing the predetermined function, or a position of the predetermined item.

13. The electronic device according to claim 1, wherein the processor is further caused to perform control to display the guide based on the event in a case where the predetermined condition is satisfied.

14. A method for controlling an electronic device, the method comprising:
performing a process of displaying a first screen including a predetermined item;
performing control to execute a predetermined function based on an operation on the predetermined item on the first screen;
performing control to display the first screen without displaying a guide regarding the predetermined item when an event where the first screen is to be displayed occurs and in a case where a predetermined condition corresponding to a state where the predetermined item is not operated even in a case where the first screen has been displayed is not satisfied; and
performing control to display the guide when an event where the first screen is to be displayed occurs and in a case where the predetermined condition is satisfied.

15. A non-transitory computer-readable storage medium storing one or more programs configured to cause at least one processor to execute a method, the method comprising:
performing a process of displaying a first screen including a predetermined item;
performing control to execute a predetermined function based on an operation on the predetermined item on the first screen;
performing control to display the first screen without displaying a guide regarding the predetermined item when an event where the first screen is to be displayed occurs and in a case where a predetermined condition corresponding to a state where the predetermined item is not operated even in a case where the first screen has been displayed is not satisfied; and
performing control to display the guide when an event where the first screen is to be displayed occurs and in a case where the predetermined condition is satisfied.
